(19) United States
(12) Patent Application Publication
(10) Pub. No.: US 2009/0013868 A1
(43) Pub. Date: Jan. 15, 2009

(54) PROCESS AND APPARATUS FOR THE SEPARATION OF A GASEOUS MIXTURE

(76) Inventors: Arthur Darde, Paris (FR); Bao Ha, San Ramon, CA (US); Jean-Pierre Tranier, L'Hay-Les-Roses (FR)

Correspondence Address: AIR LIQUIDE;Intellectual Property, 2700 POST OAK BOULEVARD, SUITE 1800, HOUSTON, TX, 77056, US

(21) Appl. No.: 11/776,492

(22) Filed: Jul. 11, 2007

(51) Int. Cl. B01D 19/00; B01D 3/14; B01D 53/00

(52) U.S. Cl. 95/42; 202/161; 96/193

(57) ABSTRACT

A process for separating carbon dioxide from a compressed, dried and cooled carbon dioxide containing fluid comprises separating the fluid into at least a carbon dioxide enriched stream, and a carbon dioxide depleted stream, expanding at least part of the carbon dioxide lean stream in an expander, compressing a process stream wherein the power for the compression step is at least in part provided by the power generated by the expander.

### TECHNICAL FIELD

The present invention relates to a process and apparatus for the separation of gaseous mixture containing carbon dioxide as main component. It relates in particular to processes and apparatus for purifying carbon dioxide, for example coming from combustion of a carbon containing fuel, such as takes place in an oxycombustion fossil fuel or biomass power plant.

### BACKGROUND ART

The combustion of carbon containing fuels (biomass, waste, fossil fuels such as coal, lignite, hydrocarbons, . . . ) produces CO₂ and gases, such as SO₂, SO₃, NOx, which pollute the atmosphere and are major contributors to the greenhouse effect especially CO₂. These emissions of CO₂ are concentrated in four main sectors: power generation, industrial processes, transportation, and residential and commercial buildings. The main application of CO₂ capture is likely to be in power generation and large energy consuming industries, particularly cement, iron and steel and chemical production and oil refining. Capturing CO₂ directly from small and mobile sources in the transportation and domestic and commercial buildings sectors is expected to be significantly more difficult and expensive. Most of the emissions of CO₂ to the atmosphere from the electricity generation and industrial sectors are currently in the form of flue gas from combustion, in which the CO₂ concentration is typically 4-14% by volume, although CO₂ is produced at high concentrations by a few industrial processes. In principle, flue gas could be stored, to avoid emissions of CO₂ to the atmosphere it would have to be compressed to a pressure of typically more than 100 bar abs and this would consume an excessive amount of energy. Also, the high volume of the flue gas would mean that storage reservoirs would be filled quickly. For these reasons it is preferable to produce relatively high purity stream of CO₂ for transport and storage; this process is called CO₂ capture. This carbon dioxide could be used for enhanced oil recovery or just injected in depleted gas and oil fields or in aquifers.

The present invention is based on application to the power generation sector. Nevertheless, it could also be applied to flue gases coming from other industrial processes with a relatively high purity, above 50% by volume (dry base).

There are three main techniques for capture of CO₂ in power plants:
Post-combustion: the flue gas from a power station is scrubbed with a chemical solvent such as an aqueous solution of amines which will remove the CO₂ by absorption;
Pre-combustion: the fuel together with oxygen is sent to a gasifier where a synthesis gas (main component of the mixture: H₂, CO and CO₂) is produced. CO is then shifted to H₂ and CO₂ (CO+H2O<>CO₂+H₂) and CO₂ is scrubbed by a physical or chemical solvent. A mixture containing essentially H₂ and N₂ is sent to a gas turbine where it is burnt; and
Oxycombustion: in order to increase the carbon dioxide content in the flue gas, the fuel is burnt with a mixture of mainly carbon dioxide and oxygen instead of air. This mixture of oxygen and carbon dioxide is obtained by recycling part of the flue gas rich in carbon dioxide and mixing it with oxygen (typically at 95% purity) coming from a cryogenic air separation unit. The flue gas is then purified in order to remove components like water and oxygen and compressed to a pressure between 100 and 200 bar abs in order to be injected underground (see FIG. 1). It should be noted that the recycling of flue gases would not be necessary with high temperature materials for the boiler. However, they do not exist at the time of invention. The recycling of flue gases is not mandatory for the invention disclosed here in.

EP-A-0503910 describes a process for the recovery of carbon dioxide and other acid gases from flue gases coming from a power plant using the oxycombustion technique.

A more recent document on the same subject is “Oxy-Combustion Processes for CO₂ Capture from Power Plant” IEA Report No. 2005/9, September 2005, Process Flow Diagrams 6, p. 1, and 11, p. 1.

The purpose of this invention is to improve the solution proposed in this patent both in term of specific energy and/or carbon dioxide recovery and/or carbon dioxide product purity.

### SUMMARY OF THE INVENTION

According to an aspect of the invention, there is provided a process for separating carbon dioxide from a compressed, dried, and cooled carbon dioxide containing fluid comprising the steps of:
i) separating the fluid into at least a carbon dioxide enriched stream, and at least a carbon dioxide depleted stream;
ii) expanding at least part of the carbon dioxide depleted stream in an expander; and
iii) compressing a stream chosen from the group comprising the fluid upstream of step i) and at least part of one of the streams of step i),
   wherein the power for the compression step iii) is at least in part provided by the power generated by the expander of step ii).

According to optional features:
part of a fluid chosen from the group comprising the carbon dioxide depleted stream(s) is compressed in step iii);
the carbon dioxide depleted stream is richer in carbon dioxide than another stream separated in step i);
at least part of the carbon dioxide enriched stream is compressed in step iii);
the stream compressed in compression step iii) is the fluid to be separated;
the compression of step iii) takes place in a single stage impeller and the expansion of step ii) takes place in a single stage impeller on the same shaft rotating at the same speed;
the compressed stream of step iii) is recycled upstream of the separation step i); and
the separation step i) comprises cooling the compressed, dried fluid to form a cooled compressed dried fluid, sending the cooled, compressed dried fluid to a phase separator, sending at least one stream from the phase separator to a column, removing the carbon dioxide enriched stream from the column and separating the carbon dioxide depleted stream by means of phase separation alone.

According to further aspects of the invention, there is provided an apparatus for separating carbon dioxide from a flue gas comprising:
i) A separation unit for separating the flue gas into at least a carbon dioxide enriched stream, and at least a carbon dioxide depleted stream
ii) An expander and a conduit for sending at least part of the carbon dioxide depleted stream in the expander to be expanded
iii) A compressor and a conduit for sending at least part of one of the streams of step i) to the compressor wherein the compressor is coupled to the expander.

Other optional aspects include:
a conduit for sending at least part of one fluid from the group of the carbon dioxide depleted streams to the compressor;
a conduit for sending at least part of the carbon dioxide enriched stream to the compressor;
a conduit for sending at least part of the fluid to be separated to the compressor;
the separation unit comprises at least first and second phase separators, a conduit for sending at least one of feed gas and gas derived from the feed gas to the first phase separator, a conduit for removing gas from the first phase separator, said conduit being connected to the compressor, a conduit for sending compressed gas from the compressor to the second phase separator, a conduit for removing gas from the second phase separator and a conduit for sending the gas from the second phase separator to the expander; and
the apparatus further comprises a distillation column and at least one conduit for sending liquid from at least one of the first and second phase separators to the column.

### BRIEF DESCRIPTION OF DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic representation of an oxycombustion process wherein the flue gas is purified in order to remove components like water and oxygen and compressed in order to be injected underground.

FIG. 2 is a schematic view of a compression and purification unit which could be used as unit 7 in FIG. 1.

FIG. 3 shows a low temperature purification unit that could be used as unit 104 in FIG. 2.

FIG. 4 shows a heat exchange diagram for heat exchange between a vaporizing high purity carbon dioxide stream and a cooling and condensing feed stream.

FIG. 5 shows a heat exchange diagram for heat exchange between an intermediate purity carbon dioxide stream and a cooling and condensing feed stream as observed in exchanger 55 of FIG. 3.

### DETAILED DESCRIPTION OF THE INVENTION

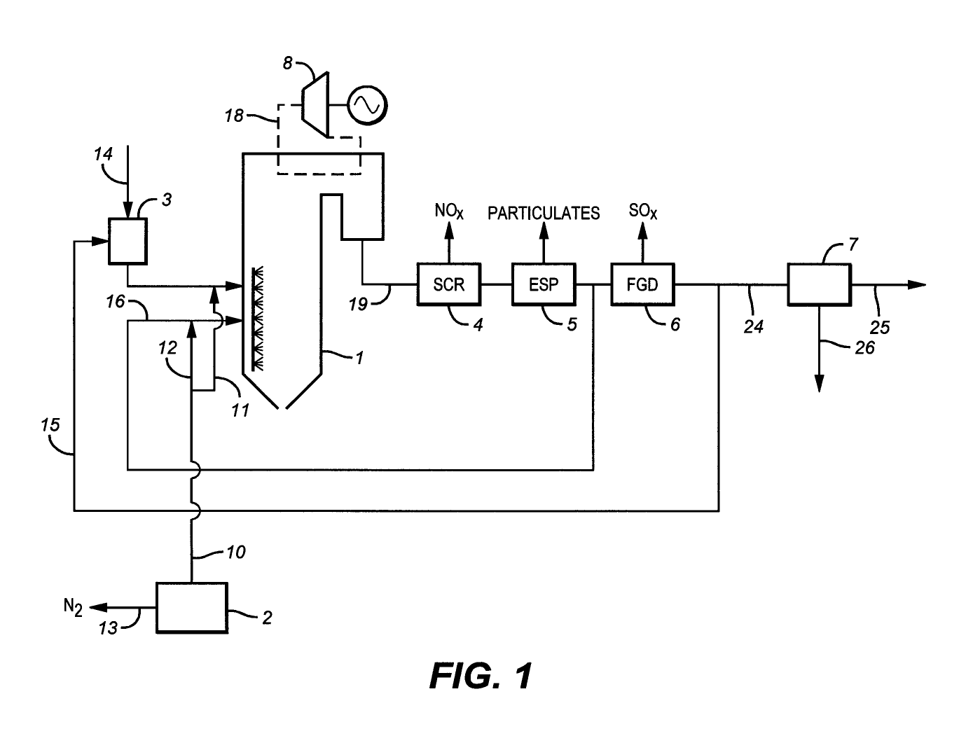

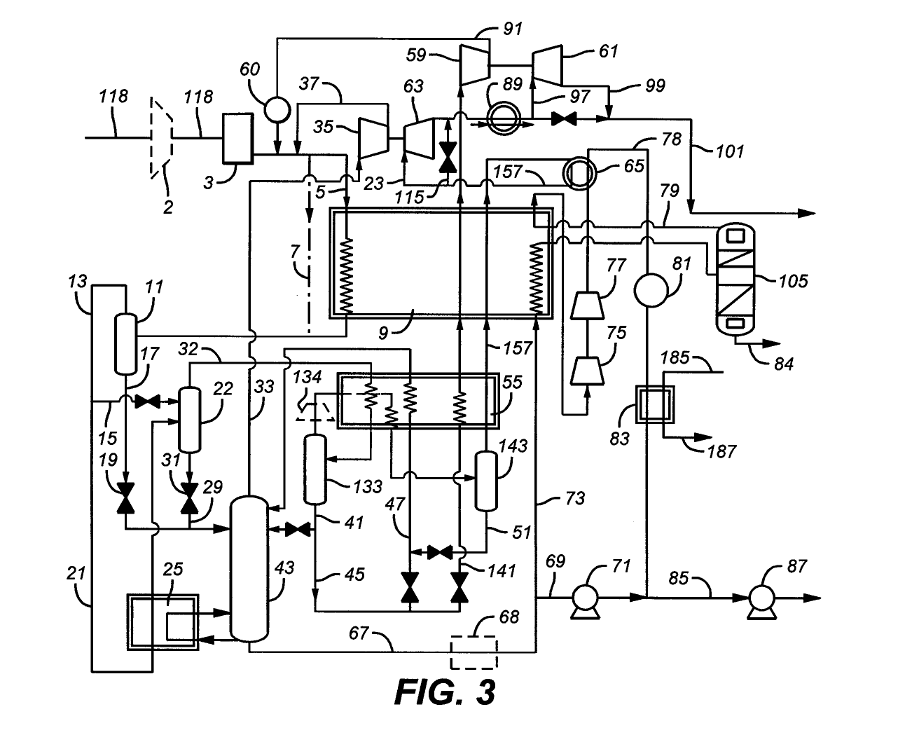

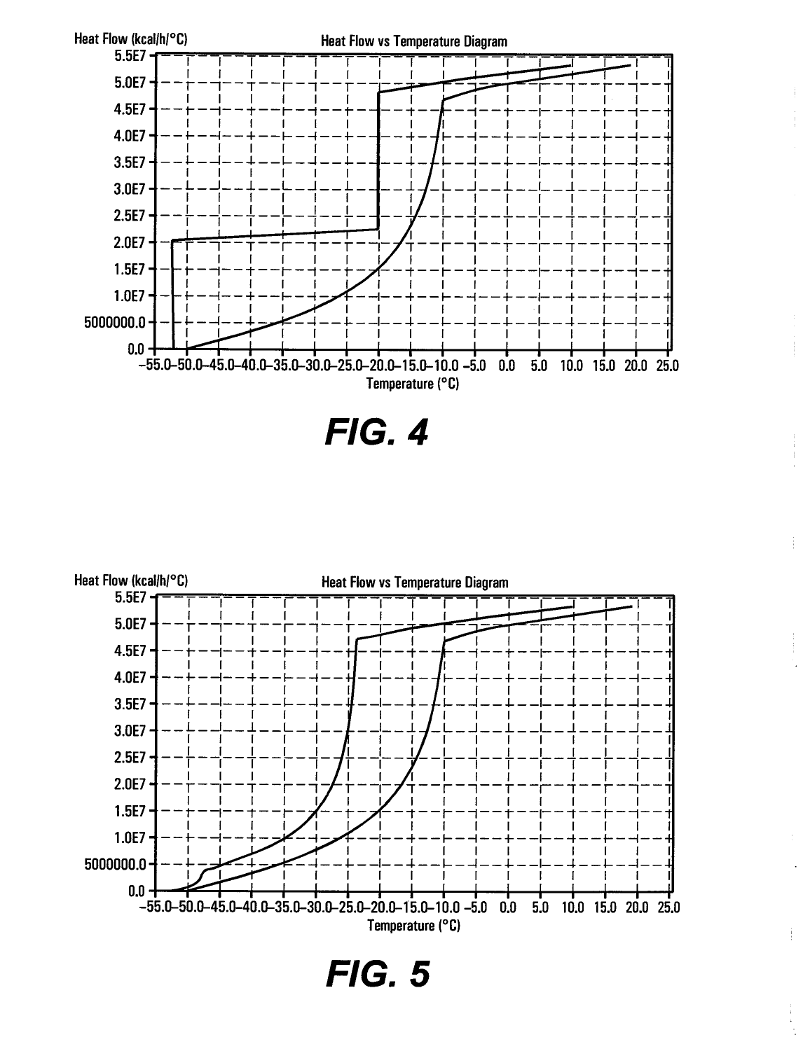

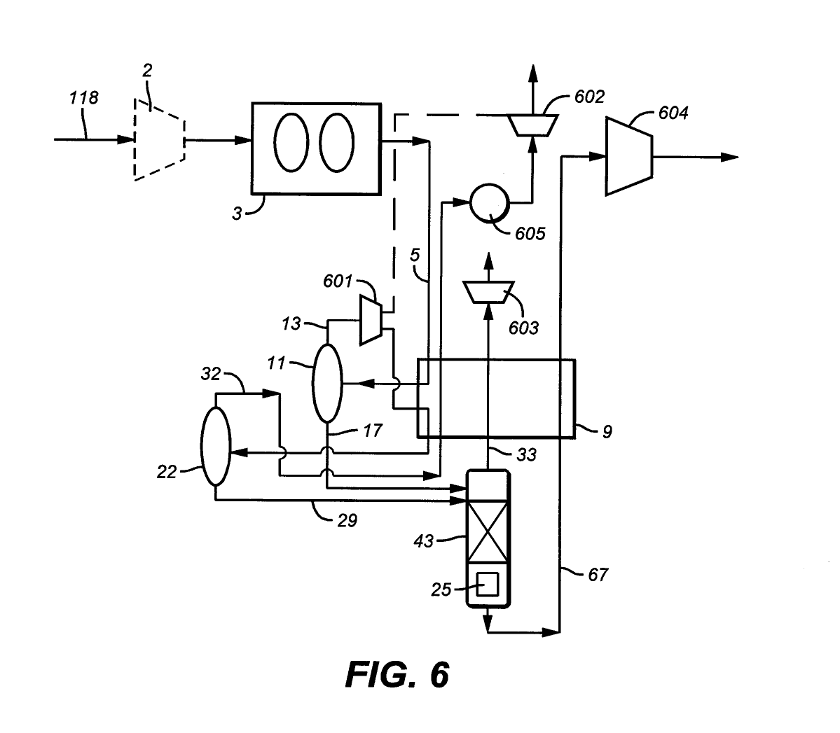

The invention will now be described in further detail with reference to the figures of which FIGS. 1, 2 and 3 show apparatuses according the invention, in varying degrees of detail, going from FIG. 1 which is the least detailed to FIG. 3 which is the most detailed. FIGS. 4 and 5 show heat exchange diagrams for the prior art and one of the exchangers of FIG. 3 respectively. FIG. 6 shows an alternative version of FIG. 3.

FIG. 1 is a schematic view of an oxycombustion plant. Air separation unit 2 produces an oxygen stream 10 at a typical purity of 95-98 mol. % and a waste nitrogen stream 13. Oxygen stream 10 is split into two sub streams 11 and 12. The primary flue gas recycle stream 15 passes through coal mills 3 where coal 14 is pulverized. Substream 11 is mixed with the recycle stream downstream of the coal mills 3 and the mixture is introduced in the burners of the boiler 1. Sub stream 12 is mixed with secondary flue gas recycle stream 16 which provides the additional ballast to the burners to maintain temperatures within the furnace at acceptable levels. Water stream(s) is introduced in the boiler 1 in order to produce steam stream(s) 18 which is expanded in steam turbine 8. Flue gas stream 19 rich in CO₂, typically containing more than 70 mol. % on a dry basis, goes through several treatments to remove some impurities. Unit 4 is NOx removing system like selective catalyst reduction. Unit 5 is a dust removal system such as electrostatic precipitator and/or baghouse filters. Unit 6 is a desulfurization system to remove SO₂ and/or SO₃. Units 4 and 6 may not be necessary depending on the CO₂ product specification. Flue gas stream 24 is then introduced in a compression and purification unit 7 in order to produce a high CO₂ purity stream 25 which will be sequestrable and a waste stream 26.

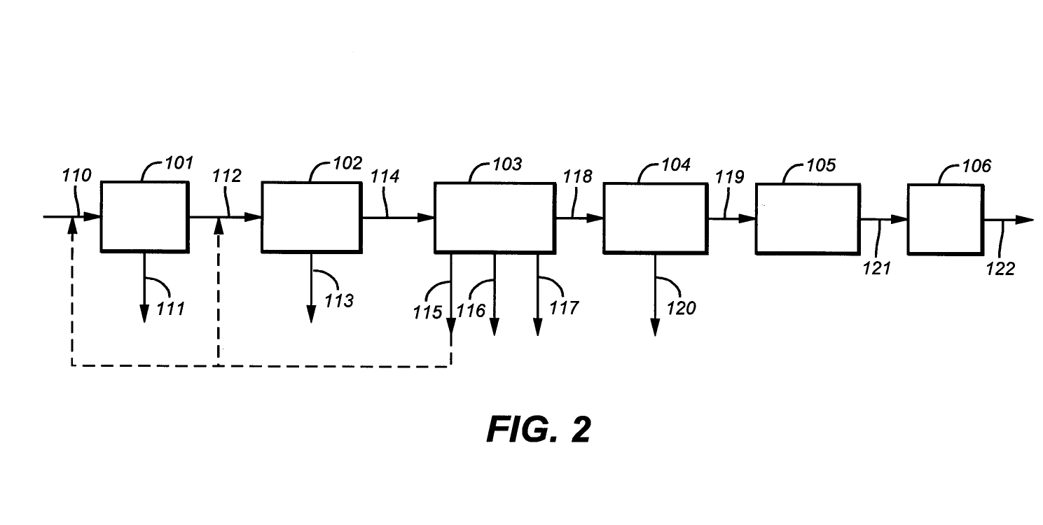

FIG. 2 is a schematic view of a compression and purification unit which could be used as unit 7 in FIG. 1. Flue gas stream 110 (corresponding to stream 24 of FIG. 1) enters a low pressure pretreatment unit 101 where it is prepared for compression unit 102. This unit could include, for example, among other steps:
a dust removal step in a wet scrubber and/or a dry process either dynamic, such as pulse-jet cartridges or static, such as pockets and cartridges;
a (further) desulfurization step in a wet scrubber with water and/or soda ash or caustic soda injection; and
a cooling step in order to minimize the flow through water condensation and the power of compression unit both due to flow and temperature reduction.

Waste stream(s) 111 could consist of condensed water, dust and dissolved species like H₂SO₄, HNO₃, Na₂SO₄, CaSO₄, Na₂CO₃, CACO . . . .

Compression unit 102 compresses stream 112 from a pressure close to atmospheric pressure to a high pressure typically between 15 and 60 bar abs, preferably around 30 bar abs. This compression could be done in several stages with intermediate cooling. In this case, some condensate(s) 113 could be produced. Heat of compression could also be recovered in these intermediate cooling step, for example to preheat boiler feed water. Hot stream 114 leaves the compression unit 102 and enters a high pressure pretreatment unit 103. This unit at least includes:
one or several cooling step(s) in order to decrease the temperature and decrease the water content; and
a drying step to remove most of the water, for example by adsorption, and could include (non-exhaustive list):
a high pressure washing column for cooling and/or purification; and
a mercury removal step.

Effluents from this unit are gaseous stream 115 (regeneration stream of the drying step) and could be liquid stream(s) 116/117 (from the cooling step and/or the high pressure washing column).

The stream 114 may contain NO₂. In this case, it is sometimes preferable to remove the NO₂ by adsorption upstream of the unit 104. In this case, the stream 114 may be treated by adsorption and the regeneration gas used to regenerate the adsorbent is removed having a content enriched in NO₂ with respect to that of stream 114. The gaseous stream 115 may be recycled at least in part upstream of the compression unit 102, upstream of the pretreatment unit 101 or to the boiler 1 of the combustion unit.

Below 158° C., NO₂ is in equilibrium with its polymer/dimer N₂O₄. The lower the temperature, the higher the concentration of N₂O₄ compared to NO₂. In this document, the word NO₂ is used to mean not only NO₂ but also its polymer/dimer N₂O₄ in equilibrium.

Unit 104 is a low temperature purification unit. In this case, low temperature means a minimum temperature in the process cycle for the purification of the flue gas below 0° C. and preferably below −20° C. as close as possible to the triple point temperature of pure CO₂ at −56.6° C. In this unit, stream 118 is cooled down and partially condensed in one (or several steps). One (or several) liquid phase stream(s) enriched in CO₂ is (are) recovered, expanded and vaporized in order to have a product enriched in CO₂ 119. One (or several) non-condensible high pressure stream(s) 120 is (are) recovered and could be expanded in an expander.

CO₂ enriched product 119 is further compressed in compression unit 105. In unit 106 compressed stream 121 is condensed and could be further compressed by a pump in order to be delivered at high pressure (typically 100 to 200 bar abs) as stream 122 to a pipeline to be transported to the sequestration site.

FIG. 3 shows a low temperature purification unit that could be used as unit 104 in FIG. 2. At least one process according to the invention operates within such a unit.

Stream 118 comprising flue gas at around 30 bar and at a temperature of between 15° C. and 43° C. is filtered in 3 to form stream 5. Stream 118 contains mainly carbon dioxide as well as NO₂, oxygen, argon and nitrogen. It may be produced by unit 103 directly at the high pressure or may be brought up to the high pressure using optional compressor 2 shown in dashed lines. Stream 5 cools in heat exchange line 9 and is partially condensed. Part 7 of stream 5 may not be cooled in the heat exchange but is mixed with the rest of stream 5 downstream of the heat exchange line to vary its temperature. The partially condensed stream is sent to first phase separator 11 and separated into gaseous phase 13 and liquid phase 17. The gaseous phase 13 is divided in two to form stream 15 and stream 21. Stream 21 is used to reboil column 43 in exchanger 25 and is then sent to a second phase separator 22. Stream 15 by-passes the reboilers in order to control the reboiling duty.

Liquid stream 17 from the first phase separator 11 is expanded in valve 19 and liquid stream 29 is expanded in valve 31, both streams being then sent to the top of column 43. Column 43 serves principally to remove the incondensable components (oxygen, nitrogen, and argon) from the feed stream.

A carbon dioxide depleted stream 33 is removed from the top of column 43 and sent to compressor 35. The compressed stream 37 is then recycled to stream 5.

A carbon dioxide enriched or rich stream 67 is removed from the bottom of column 43 and divided in two. One part 69 is pumped by pump 71 to form stream 85, further pumped in pump 87 and then removed from the system. Stream 85 corresponds to stream 25 of FIG. 1. The rest 73 provides the frigorific balance.

It is desirable to provide means for removing NO₂ from the fluid 118 to be separated. In general this involves separating at least part of the fluid 118 into a carbon dioxide enriched stream, a carbon dioxide depleted stream comprising CO₂ and at least one of oxygen, argon, and nitrogen and a NO₂ enriched stream, and recycling the NO₂ enriched stream upstream of the separation step.

The incondensable removal step (removing mainly O₂ and/or N₂ and/or Ar) may take place before or after the NO₂ removal step.

Several types of NO₂ removal step may be envisaged, involving distillation and/or phase separation and/or adsorption. The adsorption step may be carried out on a product of the CO₂ separation step or the fluid itself before separation.

In FIG. 3, after stream 69 is removed, the rest of the carbon dioxide enriched stream 73 is vaporized in heat exchange line 9 and sent to NO₂ removal column 105.

This column may have a top condenser and a bottom reboiler, as shown, the feed being sent to an intermediate point. Alternatively, there need be no bottom reboiler, in which case the feed is sent to the bottom of the column. A NO₂ depleted stream 79 is removed from the column and sent back to the heat exchange line. This stream is further warmed, compressed in compressors 75, 77, sent to heat exchanger 65, removed therefrom as stream 78, cooled in exchangers 81, 83 and mixed with stream 69 to form stream 85. Exchanger 81 may be used to preheat boiler feed water. Exchanger 83 is cooled using a refrigerant stream 185 which may be R134a, ammonia, water, water mixed with glycol or any other suitable fluid. The warmed fluid is designated as 187. A NO₂ enriched stream 84 is removed from the bottom of the column 105. This stream 84 is then recycled to a point upstream of filter 3.

Alternatively or additionally the separation phase may consist of producing the NO₂ enriched stream by adsorption of the NO₂ contained in stream 67 in adsorption unit 68.

In either case, at least part of the NO₂ enriched stream may be recycled to a unit producing the fluid, such as the combustion zone of a boiler 1, as seen previously for stream 115. It should be noted that recycling NOₓ in the combustion zone does not increase the NOₓ content in the flue gas. In other words, recycling NOₓ to the combustion zone eliminates NOx.

Additionally or alternatively at least part of the NO₂ enriched stream may be recycled to a unit for treating the fluid.

For example the NO₂ enriched stream may be recycled upstream of the compressor 2 (if present) or one of units 101, 102.

It may be advantageous to recycle at least part of the NO₂ enriched stream to a wash column, such as that of pretreatment unit 103. In this case, the NO₂ may be converted to nitric acid in the wash column and subsequently removed from the system.

In a wash column where SO₂ is present in the flue gas, the recycled NO₂ enriched stream will react with SO₂ to form NO and SO₃ that will immediately turn to H₂SO₄ with water and be removed in the water drain. Therefore, if enough NO₂ is present in the recycled stream, it is a means to remove SOₓ from the flue gas and to avoid the injection of reactants like soda ash or caustic soda or even a classical flue gas desulphurization.

Top gas 32 from the second phase separator 22 is cooled in heat exchanger 55 and sent to third phase separator 133. Part of the liquid from the phase separator 133 is sent to the column 43 and the rest as the intermediate purity stream 45 is divided in two streams 47, 141. Stream 47 is vaporized in heat exchanger 55 and sent to the top of column 43 or mixed with stream 33.

Stream 141 is expanded in a valve, warmed in heat exchangers 55, 9, compressed in compressor 59, cooled as stream 91 in heat exchanger 60, and mixed with compressed stream 5. The valve used to expand stream 141 could be replaced by a liquid expander.

The top gas from the third phase separator 133 is cooled in heat exchanger 55, optionally after compression by compressor 134 and sent to a fourth phase separator 143. The carbon dioxide lean top gas 157 from fourth phase separator 143 is warmed in heat exchanger 55, then in heat exchanger 9 as stream 157, warmed in exchanger 65 and expanded as stream 23 in expander 63, coupled to compressor 35. The carbon dioxide lean top gas 157 contains between 30 and 45% carbon dioxide and between 30 and 45% nitrogen. It also contains substantial amounts of oxygen and argon. The bottom liquid 51 from phase separator 143 is sent to the column with stream 47.

The stream expanded in expander 63 is mixed with stream 115 which does not pass through the expander and then warmed in 89. Part 97 of the warmed stream is expanded in expander 61 and sent as stream 99, 101 to the atmosphere.

The optional compressor 2 may be powered by one of expanders 61, 63.

Expander 61 is coupled to compressor 59 in the figure.

Molar fractions in % (example) for O₂, N₂, Ar, CO₂.

TABLE 1

| | FLUIDS | | | | | | |
|---|---|---|---|---|---|---|---|
| Components | 118 | 33 | 67 | 84 | 157 | 141 | 78 |
| O₂ | 2.5 | 4.8 | 0 | 0 | 13.3 | 2.3 | 0 |
| N₂ | 7.8 | 11 | 0 | 0 | 43.8 | 0.1 | 0 |
| Ar | 1.9 | 4.9 | 0 | 0 | 9.5 | 2.6 | 0 |
| CO₂ | 87.8 | 79.3 | 99.95 | 99 | 33.4 | 95 | 100 |
| NOx | 250 | 50 | 500 ppm | 1 | 5 ppm | 500 ppm | 0 |
| | ppm | ppm | | | | | |

FIG. 4 shows a heat exchange diagram for heat exchange between a vaporizing high purity carbon dioxide stream and a cooling and condensing feed stream as known from the prior art.

FIG. 5 shows a heat exchange diagram for heat exchange between an intermediate purity carbon dioxide stream and a cooling and condensing feed stream as observed in exchanger 55 of FIG. 3.

FIG. 6 shows another low temperature purification unit that could be used as unit 104 in FIG. 2. At least one process according to the invention operates within such a unit.

Stream 118 comprising flue gas at around 30 bar and at a temperature of between 15° C. and 43° C. is dried in 3 to form stream 5. Stream 118 contains mainly carbon dioxide as well as NO₂, oxygen, argon and nitrogen. It may be produced by unit 103 directly at the high pressure or may be brought up to the high pressure using optional compressor 2 shown in dashed lines. Stream 5 cools in heat exchange line 9 and is partially condensed. As in FIG. 3 but not illustrated here, part of stream 5 may not be cooled in the heat exchange but may be mixed with the rest of stream 5 downstream of the heat exchange line to vary its temperature. The partially condensed stream is sent to first phase separator 11 and separated into gaseous phase 13 and liquid phase 17. The gaseous phase 13 is compressed in compressor 601 to a pressure of 60 bars, cooled in the heat exchanger 9 and sent to the second phase separator 22 which separates the stream 13 at this high pressure. Liquid stream 17 from the first phase separator 11 is sent to the top of column 43.

The second phase separator 22 produces gaseous stream 32 and liquid stream 29. Liquid stream 29 is sent to the top of column 43. Column 43 has a bottom reboiler 25 and serves principally to remove the incondensable components (oxygen, nitrogen, and argon) from the feed stream.

The gaseous stream 32 is warmed in exchanger 9, then further warmed in a steam heater 605 and sent to expander 602. Expander 602 is preferably coupled to compressor 61.

A carbon dioxide depleted stream 33 is removed from the top of column 43, warmed in exchanger 9, and sent to expander 603. The expander 603 may be coupled to a compressor of the system.

A carbon dioxide enriched or rich stream 67 is removed from the bottom of column 43 and sent to exchanger 9. Following warming and vaporization, it is compressed to more than 110 bars in compressor 604 to form a product stream.

Means for removing NO₂ from the fluid 118 to be separated may be provided as described above.

What is claimed is:

1. A process for separating carbon dioxide from a compressed, dried, and cooled carbon dioxide containing fluid comprising the steps of:
i) separating the fluid into at least a carbon dioxide enriched stream, and at least a carbon dioxide depleted stream;
ii) expanding at least part of the carbon dioxide depleted stream in an expander; and
iii) compressing a stream chosen from the group comprising the fluid upstream of step i) and at least part of one of the streams of step i),
wherein the power for the compression step iii) is at least in part provided by the power generated by the expander of step ii).

2. The process of claim 1, wherein part of a fluid chosen from the group comprising the carbon dioxide depleted stream(s) is compressed in step iii).

3. The process of claim 3, wherein the carbon dioxide depleted stream is richer in carbon dioxide than another stream separated in step i).

4. The process of claim 1, wherein at least part of the carbon dioxide enriched stream is compressed in step iii).

5. The process of claim 1, wherein the stream compressed in compression step iii) is the fluid to be separated.

6. The process of claim 1, wherein the compression of step iii) takes place in a single stage impeller and the expansion of step ii) takes place in a single stage impeller on the same shaft rotating at the same speed.

7. The process of claim 1, wherein the compressed stream of step iii) is recycled upstream of the separation step i).

8. The process of claim 1, wherein the separation step i) comprises cooling the compressed, dried fluid to form a cooled compressed dried fluid, sending the cooled, compressed dried fluid to a phase separator, sending at least one stream from the phase separator to a column, removing the carbon dioxide enriched stream from the column and separating the carbon dioxide depleted stream by means of phase separation alone.

9. An apparatus for separating carbon dioxide from a flue gas comprising:
i) a separation unit for separating the flue gas into at least a carbon dioxide enriched stream, and at least a carbon dioxide depleted stream;
ii) an expander and a conduit for sending at least part of the carbon dioxide depleted stream in the expander to be expanded; and
iii) a compressor and a conduit for sending at least part of one of the streams of step i) to the compressor wherein the compressor is coupled to the expander.

10. The apparatus of claim 9 comprising a conduit for sending at least part of one fluid from the group of the carbon dioxide depleted streams to the compressor.

11. The apparatus of claim 9 comprising a conduit for sending at least part of the carbon dioxide enriched stream to the compressor.

12. The apparatus of claim 9 comprising a conduit for sending at least part of the fluid to be separated to the compressor.

13. The apparatus of claim 9, wherein the separation unit comprises at least first and second phase separators, a conduit for sending at least one of feed gas and gas derived from the feed gas to the first phase separator, a conduit for removing gas from the first phase separator, said conduit being connected to the compressor, a conduit for sending compressed gas from the compressor to the second phase separator, a conduit for removing gas from the second phase separator and a conduit for sending the gas from the second phase separator to the expander.

14. An apparatus of claim 13 comprising a distillation column and at least one conduit for sending liquid from at least one of the first and second phase separators to the column.
